(19) United States
(12) Patent Application Publication
(10) Pub. No.: US 2010/0300347 A1
(43) Pub. Date: Dec. 2, 2010

(54) EMERGENCY POSITION INDICATING DEVICE USING RADAR CROSS SECTION CHARACTERISTICS

(75) Inventors: Hee-Jin Kang, Daejeon (KR); Dong-Kon Lee, Daejeon (KR); Cheol-Soo Park, Anyang (KR)

Correspondence Address: AMPACC Law Group, 3500 188th Street S.W., Suite 103, Lynnwood, WA, 98037, US

(73) Assignee: Korea Maritine & Ocean Engineering Research Instit ute, Daejeon (KR)

(21) Appl. No.: 12/666,236

(22) PCT Filed: May 29, 2008
(86) PCT No.: PCT/KR08/03013

§ 371 Date: Dec. 22, 2009

(30) Foreign Application Priority Data
Jun. 22, 2007 (KR) 10-2007-0061311

(51) Int. Cl. B64B 1/40; G01D 21/00

(52) U.S. Cl. 116/2; 116/210

(57) ABSTRACT

The present invention is about the emergency position indicating device using RCS. As the present invention is to solve problems finding out the locations of victims in emergency, it allows easily to find the location of victims immediately in day/night time or even in bad weather, and exceeds the weak points of EPIRB that have 4 miles of the error range and is not applicable for individual portables, and Cyalume Lightstick that have a limit for the indication range. As floating it on the air (10˜30 m) for a long time after injecting the lighter gas than air into the balloon type equipment that contains the reflection body covered (coated) by the metal film of Dihedral or Tri-hedralal structure of which can maximize RCS, it has the characteristic to notify the locations of victims effectively by strongly reflecting the radar wave from a sailing or searching radar of adjacent ships or the rescue. Since the present invention have advantages that the locations of victims can be easily found in day/night time or marine conditions, even from a long distance, it is much effective to improve the saving rate and the surviving rate of victims in emergency.

### TECHNICAL FIELD

The present invention is about emergency position indicating device. More specifically speaking, it is about the device that the marine victims can easily notify their location to a sailing or searching radar of adjacent ships or the rescue with a strong reflection of radar wave by floating enough a balloon type device on the air (10˜30 m) after injected the lighter gas than air into which is covered (coated) by the metal film of Diheral or Tri-hedralal structure.

### BACKGROUND ART

Existing techniques are EPIRB (emergency position indicating transmitter) and Cyalume Lightstick that are commonly used for indicating the emergency position on ships, the related patents are the emergency position indicating device, Korean public patent report 10-1999-0045171(Jun. 25, 1999), and the flashlight that added the function of indicating emergency position, Korean public patent report 10-2005-006808(Jul. 30, 2004).

Out of existing emergency position indicating devices, EPIRB is installed on ships and is hard to trace immediately and precisely the position of wrecked ships and individual victims in bad weather and nighttime with 4 miles of error range. Also Cyalume Lightstick has the problem on continuing periods and indicating recognitions in day-time usage, and it is only possible to check by the naked eyes.

In the case of emergency position indicating device, Korean public patent report 10-1999-0045171(Jun. 25, 1999), the release of emergency signal using a battery is limited on its operating time and the balloon is difficult to be recognized from a long distance in nighttime.

In the case of the flashlight added with the function of indicating emergency position which is the patent of Korean public patent report 10 2004-006808(Jul. 30, 2004), it has also a limited operation time by the release of battery because it is designed to notify the emergency location with blinking of the blinker connected to the driver of battery, and its efficiency is low when the amounts of sunlight is too high in daytime.

### DISCLOSURE

### Technical Problem

The present invention is to settle problems of the existing techniques and its purpose is to check immediately the location of individual victims by adjacent ships or the rescue without any interferences of circumstance such as day- and night-time and marine conditions, using the balloon type of emergency position indicating device installed by reflection body which is covered (coated) by the metal film of Dihedral or Tri-hedralal that can maximize RCS (radar cross section) meaning the amount of radar wave reflected from colliding on the surface of substance.

### Technical Solution

In order to accomplish this object, there is provided an emergency position indicating device using the characteristic of RCS, which comprises: a balloon type of the position indicating floating material containing the reflection body covered (coated) by the metal film of Dihedral or Tri-hedralal structure that can maximize RCS; air floating system that the position indicating floating material can respond to the radar wave from a distance after connected with a this rope between the position indicating floating material and the main body; the main body manufactured with a long enough length to prevent that the rope between the position indicating floating material and the main body may tie the neck of victims; a connecting part of the one way valve and the charger mounted on the position indicating floating material that is designed to float in the air without additional battery and driving meter; the shooting device that can charge the charging material of the charger onto the position indicating floating material only push the bottom of the charger; and the hook part that can connect the safety device like lifesaving cloth to the main body and can continuously notify the location of emergency.

### ADVANTAGEOUS EFFECTS

According to the present invention, because it can check the location of individual victims and can save them immediately by adjacent ships or the rescue without any interferences of circumstance such as day- and night-time and marine conditions, using the position indicating device available for air floating installed by the reflection body which is covered (coated) by the metal film of Dihedral or Tri-hedralal structure that can maximize RCS meaning the amount of the radar wave reflected from colliding on the surface of substance, the surviving rate of victims can be dramatically improved in the existence of an accident.

### DESCRIPTION OF DRAWINGS

FIG. 1 is the systematic figure in the example of the invention.

FIG. 2 is the applicable figure expressing the example of the invention.

FIG. 3 is the related theoretical figure indicating the invention base.

### BEST MODE

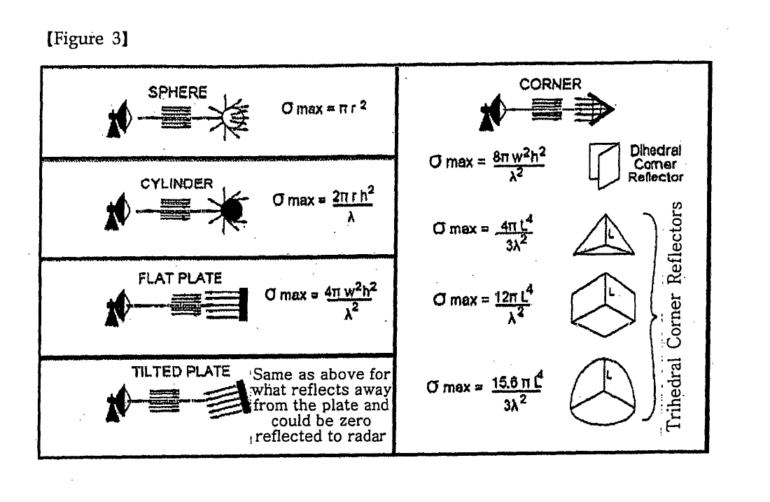

Based on the general theory about FIG. 3, the present invention is special to check effectively the location of victims by adjacent ships or the rescue from a distance as floating the position indicating floating material to high enough (10˜30 m) after charging the lighter gas (Helium etc.) into it only with push the bursting device located at the bottom of the main body, which contained the position indicating floating material that is a balloon type and is possible to float in the air, installed by the reflection body which is covered (coated) by the metal film of Dihedral or Tri-hedralal structure that can maximize the reflection area of the radar wave, and it has a strong point that is not limited by adjacent environments such as day- and night-time or marine conditions in the point of using the radar wave.

The main body has a longer enough rope than the head length not to let tie the position indicating floating material to the neck and body of victims, and victims and the emergency position indicating device should not be separated each other even without the victim intention as it can attach the hooks to lifesaving cloth of safety equipments at the bottom of the main body.

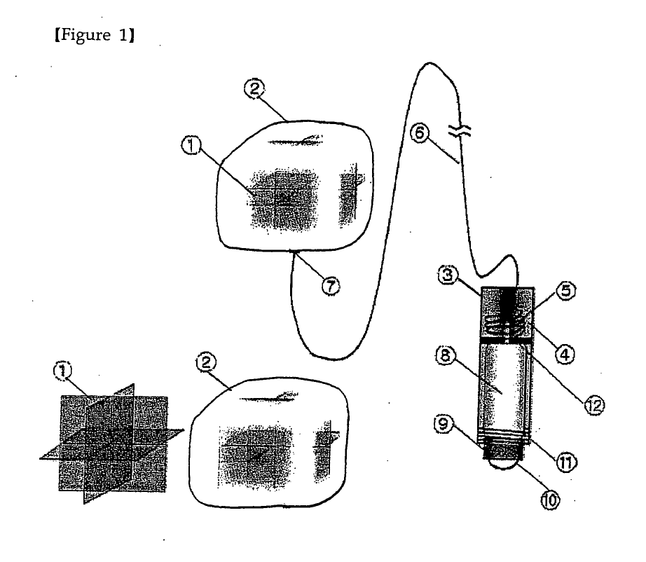

FIG. 1 represents the systematic figure in the example of the present invention.

The position indicating floating material (2) consists of the material that could penetrate the radar wave and of the reflection body covered (coated) by the metal film of Dihedral or Tri-hedralal structure that could maximize RCS. Also it can be stored inside the main body (4) as folded once not in usage.

In the case of floating position indicating floating material (2), the main body (4) has an enough length over the head of victims to prevent that the rope connected to the main body (4) may tie the neck of victims if attaching into lifesaving cloth. The one way valve (7) that can inhibit the leak of the charging material inserted in the position indicating floating material (2) and the charger (8) installed in the main body (4) are closely connected.

The position indicating floating material (2) and the main body (4) are connected with a thin rope of enough length (10˜30 m) that can effectively notify the location of victims in floating. Since the bottom of the charger (8) penetrate the spring (11) or directly connect to the shooting device (9), if victims push it is designed to charge the charging material (lighter gas than air like Helium etc.) for floating the position indicating floating material (2) by push the charger (8) with a holder (12) of the charger nozzle that allow the charger (8) forward by one touch.

Since the hook (10) that is able to connect into the main body (4) like lifesaving cloth have installed in the shooting device (9) or the main body (4), victims and the emergency position indicating device according to the present invention cannot be separated even without the victim intention.

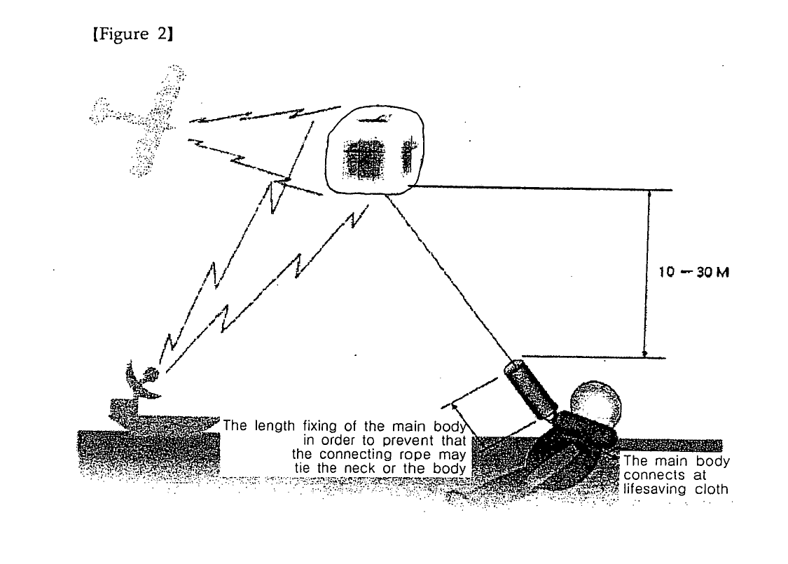

FIG. 2 is the applicable figure indicated the example of the present invention, it show the theory that floats the position indicating floating material (2) high enough (10˜30 m) using the emergency position indicating device attached to lifesaving cloth of victims and that notify its location to adjacent ships or the rescue using the radar wave reflected to the metal film (1) of the position indicating floating material (2).

As FIG. 3 introduces the basic theory about RCS (radar cross section), according to the theory indicated on FIG. 3, for the reflection body covered (coated) by the metal film (1) of Dihedral or Tri-hedralal structure, the reflection side of Tri-hedralal of which the one side length is 1 have RCS over 3500 folds than the metal reflection side of round shape which radius is 1 and have RCS 3 times bigger than the plane side regarding to the 3 Ghz ranges of radar wave. With these characteristics, we know that the present invention effectively notify the location of victims to adjacent ships or the rescue in emergency.

The foregoing embodiments are merely exemplary, and many alternatives, modifications and variations within the scope of the essentials of the present invention will be apparent to a person having ordinary skill in the art to which the present invention pertains. Accordingly, the examples disclosed in the present invention and attached drawings are provided not to limit, but to explain the technical feature of the present invention. The technical feature of the present invention is not limited by these examples and attached drawings. The scope of protection for the present invention should be interpreted based on the claims below and all of the technical features within the equivalent scope should be interpreted to be included in the scope of the present invention.

### INDUSTRIAL APPLICABILITY

According to the present invention, because it can dramatically improve the surviving rate of victims in case of emergency, this technique can achieve the practical and economical values in fields of marine shipbuilding and mechanic industry.

1. An emergency position indicating device using the characteristic of RCS, comprising:
a balloon type of the position indicating floating material containing the reflection body covered (coated) by the metal film of Dihedral or Tri-hedralal structure that can maximize RCS;
air floating system that the position indicating floating material can respond to the radar wave from a distance after connected with a this rope between the position indicating floating material and the main body;
the main body manufactured with a long enough length to prevent that the rope between the position indicating floating material and the main body may tie the neck of victims;
a connecting part of the one way valve and the charger mounted on the position indicating floating material that is designed to float in the air without additional battery and driving meter;
the shooting device that can charge the charging material of the charger onto the position indicating floating material only push the bottom of the charger; and
the hook part that can connect the safety device like lifesaving cloth to the main body and can continuously notify the location of emergency.

2. The emergency position indicating device using the characteristic of RCS of claim 1, wherein with installing a batter storage inside the main body, the emergency position indicating device using the characteristic of RCS that receive the power from the battery stored at the battery storage and that include functions such as a light, sound signal generation, a timer measuring the emergency time, and GPS.

3. The emergency position indicating device using the characteristic of RCS of claim 1, wherein the emergency position indicating device using the characteristic of RCS that the metal film is not a square but a round cross-shape, or has a modified reflection side as a multi-hedral type.
